(19) United States
(12) Patent Application Publication
(10) Pub. No.: US 2006/0236579 A1
(43) Pub. Date: Oct. 26, 2006

(54) Event autographing device and method

(76) Inventors: Roy M. Cranman, Marietta, GA (US); Charles Marcus, Atlanta, GA (US); Jack Israel, Atlanta, GA (US)

Correspondence Address: GEORGE R. REARDON, 3356 STATION COURT, LAWRENCVILLE, GA, 30044, US

(21) Appl. No.: 11/113,636

(22) Filed: Apr. 25, 2005

(51) Int. Cl. G09F 3/18

(52) U.S. Cl. 40/654.01

(57) ABSTRACT

This invention relates generally to a portable device, operable for being displayed, that facilitates autographing keepsakes items from an event, such as replica flags, and the method of making and using of the device.

### FIELD OF THE INVENTION

This invention relates generally to autographing. More particularly, this invention relates to a device and method for autographing which results in a durable, displayable memorabilia that commemorates an event.

### BACKGROUND OF THE INVENTION

More and more, people are attending sporting events and wanting to have a keepsake or memory of attendance. This may be in the form of purchasing a flag signifying a specific sporting event. For example, a replica of a golf course pin flag, a racing flag or team flag may be purchased. Additionally, a fan may have this replica flag autographed or signed by a celebrity at the event. After the fan gains one or more celebrity autographs, the fan may decide to display the autographed flag at home or at the office, sometimes by having to go to the extra expense of having it framed, sometimes by hanging it unframed.

However, present devices suffer from several drawbacks. Items such as a replica flag are usually purchased as a single item, without a protective cover and without a marking device. The process of carrying the replica flag around exposes it to the elements, allowing it to get dirty and wet. Obtaining an autograph on the replica flag can be awkward, due to not having a convenient suitable surface on which to place the replica flag prior to signing, not having a suitable pen, or both. In order to display the replica flag, additional devices are generally required, such as a mat, a frame, etc. Other obstacles exist.

Improvements are needed to facilitate the transport of the replica flag, improve the autograph process; protect the replica flag from the elements and provide a permanent display of the replica flag. Therefore, it is an object of the present invention to provide an event autographing device that overcomes these and other obstacles.

### SUMMARY OF THE INVENTION

The aforementioned and other objects were achieved, and the above-mentioned disadvantages overcome, by the present invention, by providing an event autographing device designed to be display-ready, portable and easy to sign.

The present invention is comprised of an autograph member, that is disposed for signing, e.g., a replica flag. The present invention is further comprised of a support member that is positioned behind the keepsake member and is roughly the same dimensions. The present invention is further comprised of a protective holding assembly that is made from flexible see-through material, e.g. vinyl or plastic, where the protective holding assembly is dimensioned to snugly contain the keepsake member and support member, yet allow for removal of either. The protective holding assembly is further comprised of means for releasable closing, e.g. hook and loop fasteners, corresponding male and female snaps, clasps, ties and the like. Means for holding a writing instrument is affixed to the protective holding member, e.g. a cavity operable for holding a writing instrument. A description or brand tag may be enclosed as a separate member in the protective case. The protective holding assembly may be further comprised of means for carrying, e.g. a handle. This means for carrying may also serve as means for hanging when the fan elects to display the keepsake member. The present invention may also include an informational member giving information about the event, e.g. a card stating the date, place, event title, etc.

The general design is for the present invention to protect the item to be autographed, facilitate easy access to the item to be autographed, facilitate the autographing process and facilitate later display of the autographed item.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

The accompanying drawings illustrate a complete embodiment of the invention according to the best modes so far devised for the practical application of the principles thereof, and in which:

FIG. 1 shows front plan view of an event autographing device according to a preferred embodiment of the present invention.

FIG. 2 shows a front plan view of a holder base used to form an event autographing device according to a preferred embodiment of the present invention.

FIG. 3 shows a front plan view of a top strip used to form an event autographing device according to a preferred embodiment of the present invention.

FIG. 4 shows a front plan view of a U-Strip used to form an event autographing device according to a preferred embodiment of the present invention.

FIG. 5 shows a front plan view of a pen holder used to form an event autographing device according to a preferred embodiment of the present invention.

FIG. 6 shows a front plan view of the assembled holder base, top strip, U-strip and pen holder according to a preferred embodiment of the present invention.

FIG. 7 shows a back plan view of an event autographing device according to a preferred embodiment of the present invention.

FIG. 8 shows a front plan view of a support member used to form an event autographing device according to a preferred embodiment of the present invention.

FIG. 9 shows a front plan view of the assembled holder base, top strip, U-strip, pen holder and support member according to a preferred embodiment of the present invention.

FIG. 10 shows a front plan view of an autograph member used to form an event autographing device according to a preferred embodiment of the present invention.

FIG. 11 shows a front plan view of an event autographing device in a folded and closed position, according to a preferred embodiment of the present invention.

FIG. 12 show a back plan view of a holder base used to form an event autographing device, according to a preferred embodiment of the present invention.

### DETAILED DESCRIPTION OF THE INVENTION

The drawings show aspects of the invention. As the drawings are described, reference will be made to the present preferred embodiments of the invention. The terminology used herein to describe the present preferred embodiments is for the purpose of clarification. The invention, however, is not intended to be limited to the specific terminology used. Terminology used to describe each element should be understood to include all technical equivalents that operate in a similar manner to accomplish similar functions.

The present invention is described in relation to an event autographing device. Nonetheless, the characteristics and parameters pertaining to various embodiments the device and methods described herein may be applicable for other uses.

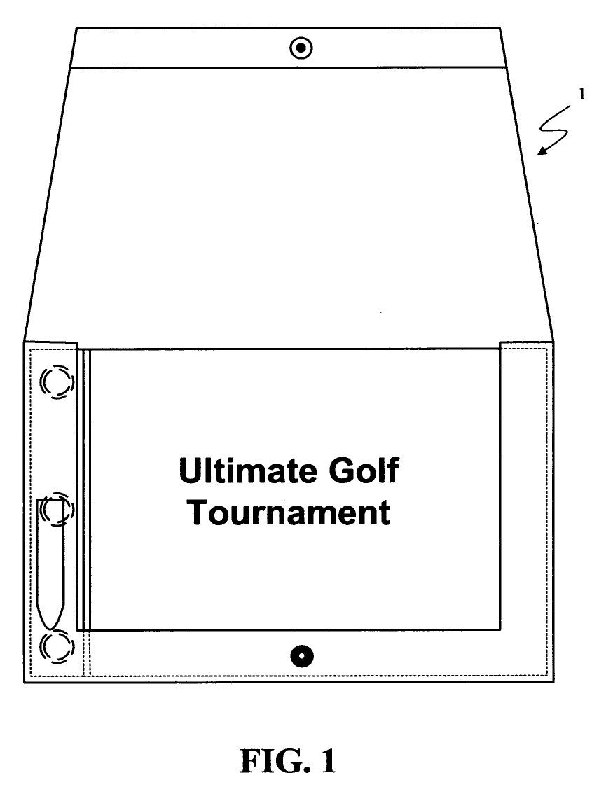

Referring to FIG. 1, the preferred embodiment of the present invention is shown as device 1.

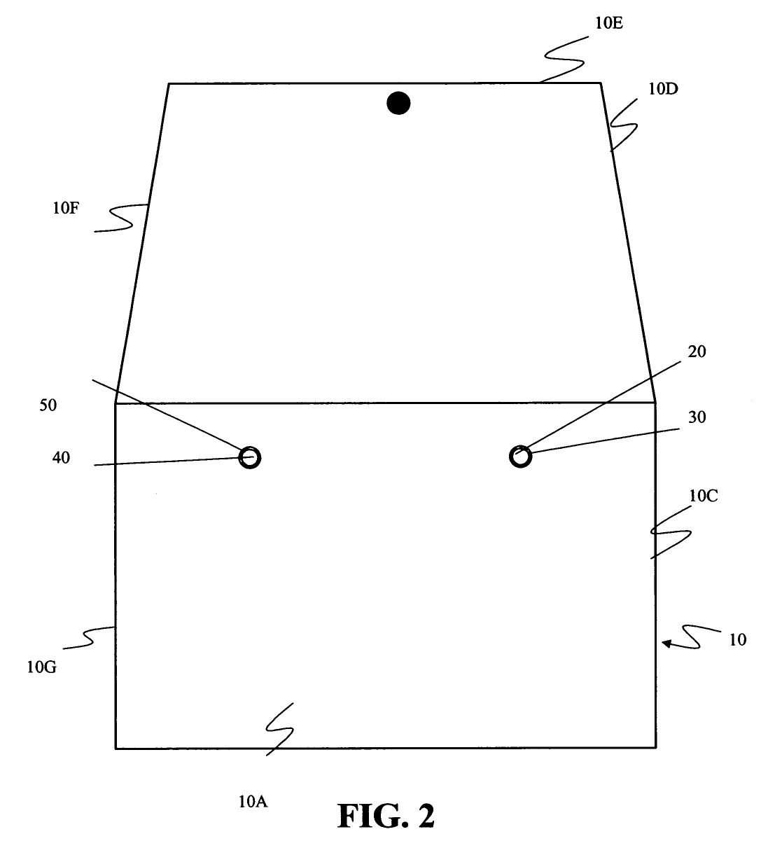

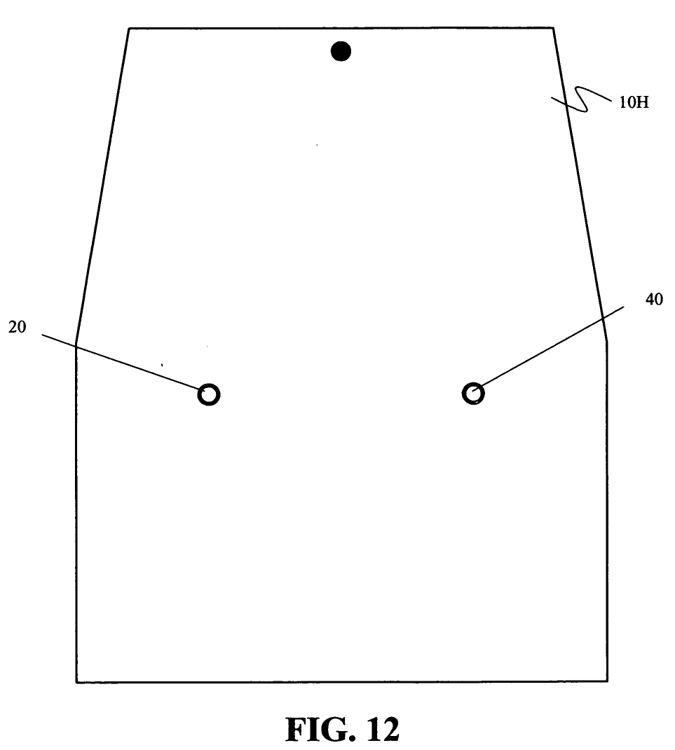

Referring to FIG. 2 and FIG. 12, holder base 10 is shown, generally comprising front side 10A, back side 10H, bottom side 10B, top side 10E, lower right side 10C, upper right side 10D, lower left side 10G and upper left side 10F. Holder base 10 is preferably made from a clear flexible vinyl material enabled for folding top side 10E towards bottom side 10B. Holder base 10 is further comprised of right hole 20, right grommet 30, left hole 40 and left grommet 50. Top side 10E is preferably about ½″ shorter than bottom side 10B.

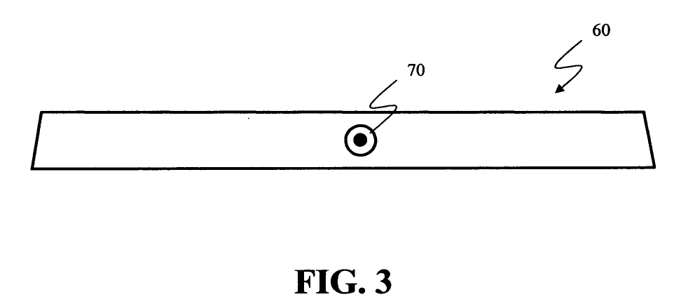

Referring to FIG. 3, top strip 60 is formed from a clear flexible vinyl material. Top strip 60 is dimensioned to align with top side 10E, upper right side 10E and upper left side 10F. Top strip 60 is further comprised of female snap 70, which is secured to top strip 60 in roughly the position shown in FIG. 3, with the engaging end of female snap 70 frontward facing. The assembly of top strip 60 and female snap 70 is then affixed to front side 10A by aligning top strip 60 with top side 10E, with the engaging end of female snap 70 frontward facing.

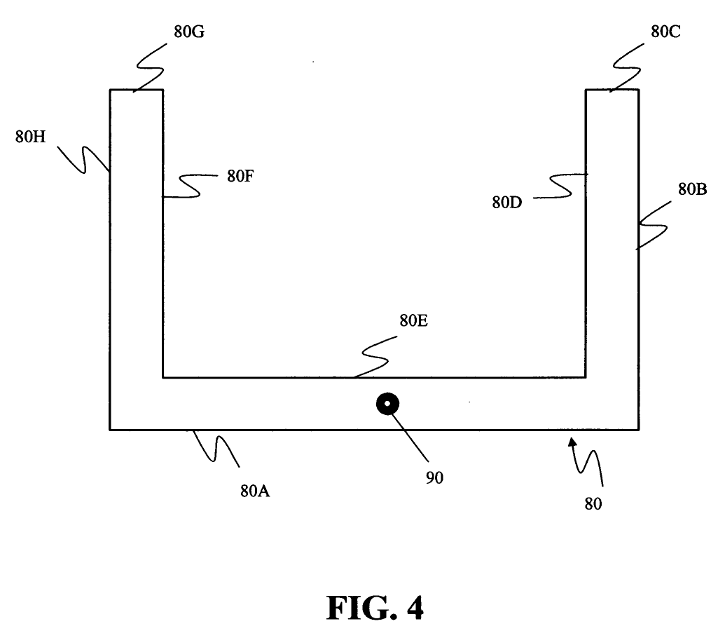

Referring to FIG. 4, U-strip 80 is formed from a clear flexible plastic material. U-strip 80 is further comprised of U-strip bottom side 80A, U-strip left outside 80H, U-strip top left side 80G, U-strip left inside 80F, U-strip bottom inside 80E, U-strip right inside 80D, U-strip top right 80C, U-strip right outside 80B, U-strip front side 80I and u-strip back side 80J (not shown). U-strip 80 is further comprised of male snap 90, which is secured in roughly the position shown in FIG. 4, with the engaging end facing frontward, and positioned for operably engaging female snap 70. The assembly of U-strip 80 and male snap 90 is then affixed to front side 10A by aligning U-strip 80 with bottom side 10B, lower left side 10G and lower right side 10C with the engaging end of male snap 90 frontward facing. Only a small portion of the edges of U-strip right outside, U-strip left outside and U-strip bottom side are affixed to front side 10A, in order to form a retainer for suitably shaped inserted objects.

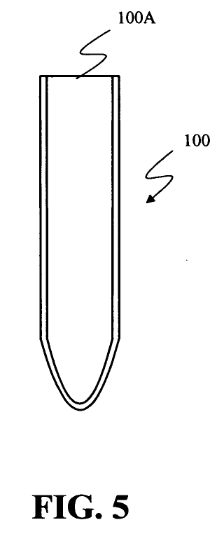

Referring to FIG. 5, pen holder 100 is formed from a clear flexible vinyl material of a size and shape that will accommodate an indelible marking pen that can be used for autographing, e.g., the material is bowed to accommodate a pen, with the largest degree of bow being at pen holder top side 10A.

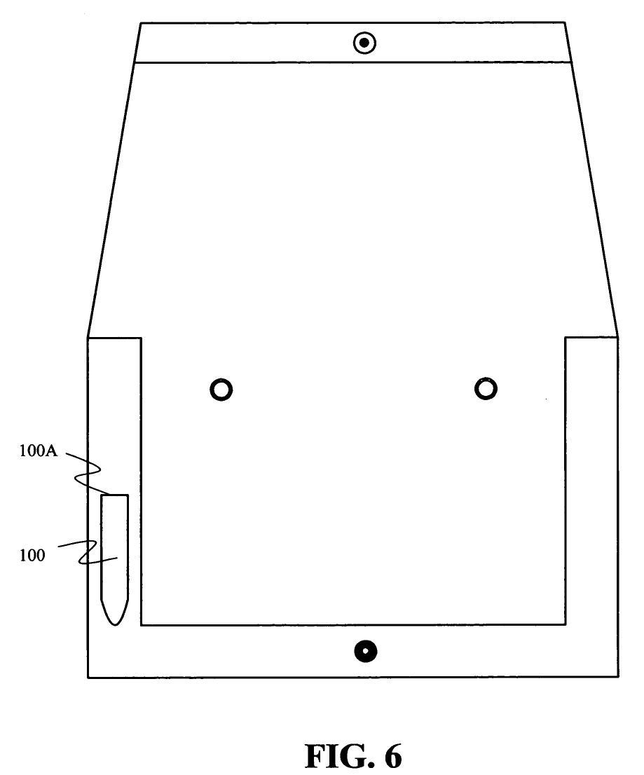

Referring to FIG. 6, the affixing of the U-strip assembly and the top strip assembly to the holder base 10 forms a protective holding assembly. Pen holder 100 is affixed to U-strip 80, preferably by a heat seal process, in roughly the position shown, with all sides of pen holder 100 being affixed to U-strip 80 except for pen holder top side 100A, thus forming a cavity for the holding of an indelible marking pen.

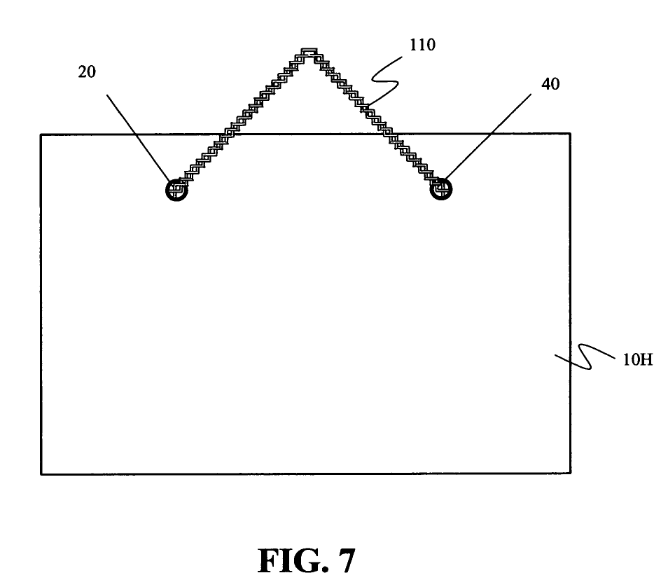

Referring to FIG. 7, handle 110 is comprised of a flexible, preferably woven, material, e.g. rope-like cord made from cotton or synthetic material. Handle 110 is passed through right hole 20 and left hole 40 from back side 10H and made operable for being secured to front side 10A, e.g. by tying a knot in each end of handle 110, with each knot being of sufficient size that the size precludes removal of handle 110.

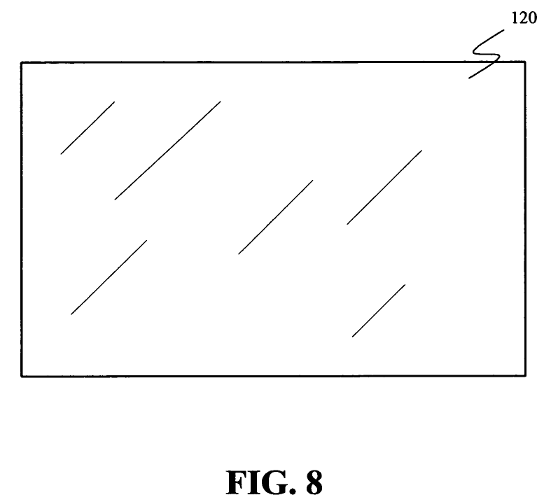

Referring to FIG. 8, support member 120 is dimensioned to fit within the space created by the affixing of U-strip 80 to front side 10A. Support member 120 can be made from any suitable material that will provide support for the autographing process, e.g. cardboard.

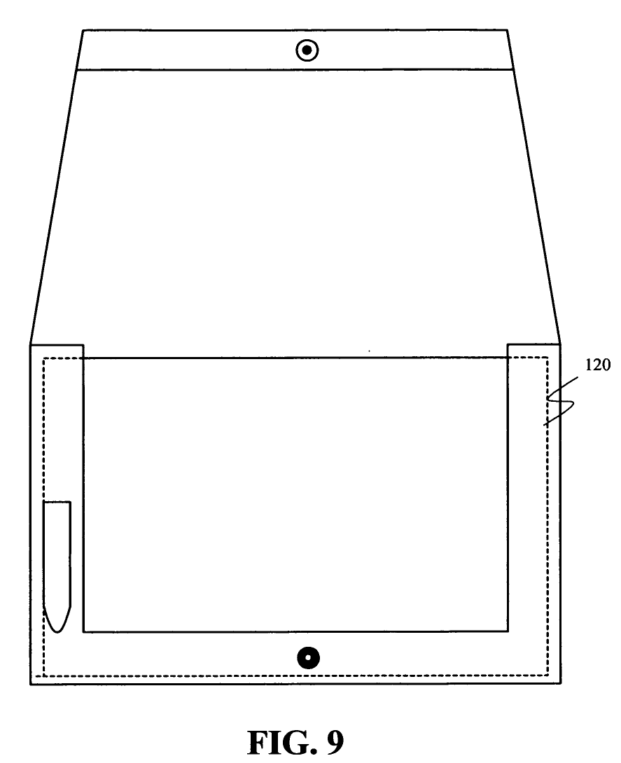

Referring to FIG. 9, support member 120 is placed within the space created by the affixing of U-strip 80 to front side 10A.

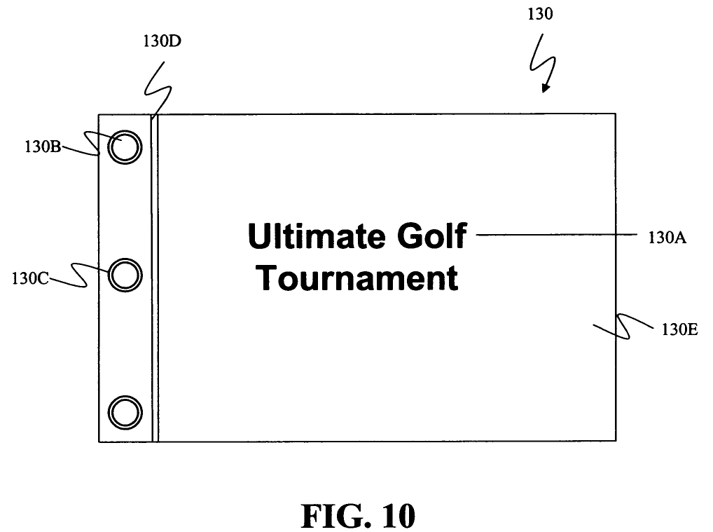

Referring to FIG. 10 and FIG. 1, autograph member 130 is made of a material conducive for autographing, e.g. cloth, plastic, metal and the like. Autograph member 130 is preferably comprised of autograph area 130E, logo area 130A, at least one flag hole 130B, at least one flag grommet 130C and seam 130D. Autograph member 130 is placed within the space created by the affixing of U-strip 80 to front side 10A and on the forward facing side of support member 120.

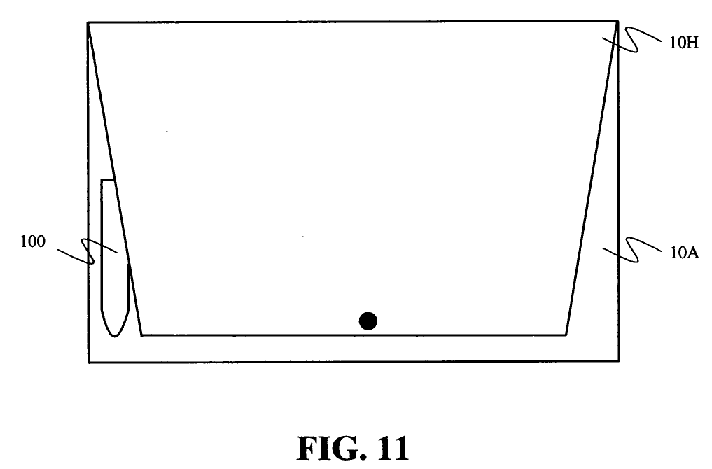

Referring to FIG. 11, holder base 10 is folded such that female snap 70 operably engages male snap 90 and forms an envelop like structure with back side 10H now being forward facing, just as is front side 10A. An indelible writing pen 140 (not shown) is then placed in pen holder 100.

The process of making device 1 is as follows:
Obtaining a sheet of flexible clear vinyl,
Forming a base member from the sheet of vinyl,
Forming a top strip from the sheet of vinyl,
Forming a U-strip from the sheet of vinyl,
Forming a pen holder from the sheet of vinyl,
Forming an autograph support member from cardboard,
Obtaining a snap enclosing device comprising a female snap portion and a male snap portion,
Securing the female snap portion to the top strip in the forward facing position to form a top strip assembly,
Securing the male snap portion to the U-strip in the forward facing position to form a U-strip assembly,
Affixing the top strip assembly to the top front of the base member,
Affixing the U-strip assembly to the bottom front of the base member to form a receiving area,
Affixing the pen holder to the front of the U-strip assembly,
Obtaining a support member dimensioned to fit into the receiving area,
Placing the support member into the receiving area,
Obtaining an autograph member dimensioned to fit into the receiving area in front of the support member,
Placing the support member into the receiving area in front of the support member,
Placing an indelible marker into the cavity of the pen holder, and
Inserting the male snap into the female snap until closure is obtained.

The process of using device 1 is as follows:
Obtaining device 1,
Targeting a subject to sign the autograph member,
Getting agreement by the subject to sign the autograph member,
Opening the device by disengaging the female snap from the male snap,
Removing the indelible marker from the pen holder,
Having the subject sign the autograph member,
Placing the indelible marker into the pen holder, and
Closing the device by engaging the male snap into the female snap.

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention.

Other embodiments, uses and advantages of the present invention will be apparent to those skilled in the art from consideration of the specification and practice of the invention disclosed herein. The specification and examples should be considered exemplary only.

What is claimed is:

1) An event autographing device, comprising:
an autograph member;
a support member;
a protective holding assembly;
means for releasable closing of said protective holding assembly;
means for holding a writing instrument; and,
a writing instrument member.

2) The event autographing device of claim 1, further comprising an informational member.

3) The event autographing device of claim 2, wherein said means for holding a writing instrument is affixed to said protective holding assembly.

4) The event autographing device of claim 3, wherein said autograph member is a replica flag.

5) A method of making an event autographing device, comprising the steps of:
obtaining a sheet of flexible clear vinyl;
forming a base member from said sheet of vinyl, such that said base member has a front, a back, a top and a bottom;
forming a top strip from said sheet of vinyl;
forming a U-strip from said sheet of vinyl;
forming a writing instrument holder from the sheet of vinyl;
obtaining means for releasable closing;
securing said means for releasable closing to said top strip to form a top strip assembly;
securing said means for releasable closing to said U-strip to form a U-strip assembly;
affixing said top strip assembly to the top of said front of said base member;
affixing said U-strip assembly to the bottom of said front of said base member to form a receiving area;
affixing said writing instrument holder to said front of said U-strip assembly;
obtaining a support member dimensioned to fit into said receiving area;
placing said support member into said receiving area;
obtaining an autograph member dimensioned to fit into said receiving area in front of said support member;
placing said support member into said receiving area in front of said support member;
placing an indelible marker into the cavity of said writing instrument holder; and,
engaging said means for releasable closing until closure is obtained.

6) A method of using an event autographing device comprising the steps of:
obtaining an event autographing device containing an autograph member and an indelible marker placed in a writing instrument holder;
targeting a subject to sign said autograph member;
getting agreement by said subject to sign said autograph member;
opening the event autographing device
removing said indelible marker from said writing instrument holder;
having said subject sign said autograph member;
placing said indelible marker into said writing instrument holder; and
closing said event autographing device.
